(19) United States
(12) Patent Application Publication
(10) Pub. No.: US 2015/0059524 A1
(43) Pub. Date: Mar. 5, 2015

(54) AUTOMATED MANUAL TRANSMISSION

(71) Applicant: Tenergy, Gyeonggi-do (KR)

(72) Inventor: Secheol Kim, Gyeonggi-do (KR)

(21) Appl. No.: 14/394,491

(22) PCT Filed: Apr. 16, 2013
(86) PCT No.: PCT/KR2013/003208

§ 371 Date: Oct. 15, 2014

(30) Foreign Application Priority Data
Apr. 17, 2012 (KR) 10-2012-0039559

(51) Int. Cl. F16H 47/06; F16H 3/089

(52) U.S. Cl. CPC F16H 47/06; F16H 3/089; F16H 2200/0026; F16H 2200/0052
USPC 74/718

(57) ABSTRACT

The present invention relates to an automated manual transmission comprising: a first gearshift unit (10) connected to the turbine of a torque converter connected to an engine and driven by the engine; a second gearshift unit (20) that includes an auxiliary input gear unit (30) and is connected to the impeller of the torque converter; and the auxiliary input gear unit (30). The first gearshift unit (10) increases or reduces the RPM of the power from the engine (1) transferred by means of the torque converter by a certain gear ratio and transmits the power to a drive wheel (50). The second gearshift unit (20) is directly coupled to the engine (1) and increases or reduces the RPM of the power from the engine (1) transferred by means of each gear by a certain gear ratio and transmits the power to a drive wheel (41). The auxiliary input gear unit (30) uses a clutch (32) to regulate an auxiliary gear (31) and a first input shaft (11) connected to an output shaft (40), and transmits the rotational force of the engine (1) to the drive wheel (50) by means of the auxiliary gear (31) and the clutch (32) while the first gearshift unit (10) or the second gearshift unit (20) are shifting gears.

### TECHNICAL FIELD

The present invention relates to an automated manual transmission, and in particular to an automated manual transmission which makes it possible to obtain a smooth driving during a low speed driving in such a way that a driving force of an engine is transferred through a first gearshift gear which is formed of a torque converter and is connected to a turbine of the torque converter, while providing a good speed change feeling by transferring a driving force of an engine to driving wheels through an auxiliary gear during a speed change.

### BACKGROUND ART

In general, the transmission of a vehicle is a device for changing a driving force from an engine into a predetermined torque based on the speed and transferring the torque. The engine can operate within a range of constant revolutions so as to let the wheels rotate at a predetermined resolution which is necessary to the driving of the vehicle as the speed of the vehicle becomes fast.

Such a transmission may be categorized into a manual transmission that a driver can directly handle to change the speed using a clutch pedal, and an automated transmission which automatically performs a speed change based on the driving condition of the vehicle using an electronic device, etc.

The automated manual transmission is a kind of a transmission which has the advantages of both the manual transmission and the automated transmission. The handling during the driving is the same as the automated transmission, so the driver may have convenience. Since the driving force such as a clutch operation oil pressure during the driving is not necessary, efficiency is high, and the automated manual transmission is good in terms of fuel efficiency.

The automated manual transmission includes a hydraulic device or an electric motor for the sake of an automated gear speed change of the transmission.

When the gear speed change is completed by such a hydraulic device or electric motor, the rotational force of the engine is transferred to the transmission with the aid of the operation of the clutch, and the rotational force of the engine increases or decreases through the speed-changed gear, and the increased or decreased rotational force is transferred to the driving wheels.

The above-described technical construction is provided for the sake of better understanding of the present invention, and does not mean the conventional art widely known in the technical field to which the present invention pertains.

### DISCLOSURE OF INVENTION

The conventional automated manual transmission has a problem wherein acceleration performance is degraded because the rotational force of an engine is not well transferred to the driving wheels during the gear speed changes.

In addition, the intermittence of the cutch is automated, but it is hard to properly handle based on any change in the operative load due to the abrasion of the clutch or a slanted angle on an uphill way, so the vehicle may be pushed backward when starting on the uphill way or the durability may be severely degraded due to the increased abrasion of the clutch disk.

The present invention is made to improve the above-mentioned problems. It is an object of the present invention to provide an automated manual transmission characterized in that the acceleration performance may be improved by transferring the rotational force of the engine to the driving wheels during the gear speed change, and the vehicle may smoothly start on the uphill way using the torque converter, and the riding comfort may be improved during the low speed driving.

To achieve the above object, there is provided an automated manual transmission including a first gearshift speed change gear unit and a second gearshift speed change gear unit configured to transfer a driving force to driving wheels by increase or decrease the rotational speed of the engine; and an auxiliary input gear unit configured to transfer the rotational force of the engine to the driving wheels during the speed change operations of the first and second gearshift speed change gear units.

The first gearshift speed change gear unit includes a first input shaft connected to the torque converter; a first gearshift gear installed at each of a first input shaft and an output shaft for thereby transferring the driving force; and a synchronizer which intermits the first gearshift gear and the output shaft.

The second gearshift speed change gear unit includes a second input shaft which is connected to an impeller of the torque converter connected to the engine to rotate for thereby integrally rotating along with the engine; a speed change gear which is installed at each of the second input shaft and the output shaft for transferring the driving force; and a synchronizer which intermits the second input shaft or the output shaft and the speed change gear.

The auxiliary input gear unit includes an auxiliary gear installed at each of the first input shaft and the output shaft; and a clutch which is installed between the auxiliary gear and the first input shaft for thereby controlling the rotations of the first input shaft.

The automated manual transmission according to the present invention is characterized in that since the rotational torque is transferred to the driving wheels through the auxiliary input gear during the gear speed change at the first gearshift speed change gear unit or the second gearshift speed change gear unit, the acceleration performance and speed change feeling of the vehicle may be improved because there is not any run up of the engine or any disconnection of the driving force during the gear speed change.

In addition, the first gearshift gear is configured to transfer a driving force through the turbine of the torque converter, so the driving torque may be increased based on the increase of the torque, and the driving at the low speed may be smooth thanks to the buffer action of the torque converter.

### BRIEF DESCRIPTION OF DRAWINGS

FIG. 1 is a view illustrating a state wherein a driving force is transferred through a first gearshift speed change gear unit in an automated manual transmission according to an exemplary embodiment of the present invention.

FIG. 2 is a view illustrating a state wherein a driving force is transferred through a second gearshift speed change gear unit in an automated manual transmission according to an exemplary embodiment of the present invention.

FIG. 3 is a view illustrating a state wherein a driving force is transferred through an auxiliary input unit in an automated manual transmission according to an exemplary embodiment of the present invention.

*Legend of Reference Numbers on the
key components of the drawings*

1: engine 2: drive plate 3: torque converter impeller 4: torque
converter turbine 5: damper spring 6: stator 7: one-way clutch 8: torque
converter housing 9: oil seal
10: first gearshift speed change gear unit 11: first input shaft 12:
first gearshift gear 13: 1/2-th gearshift synchronizer
20: second gearshift speed change gear unit 21: second input
shaft 22: second gearshift gear 23: third gearshift gear 24: fourth gearshift
gear 25: 3/4-th gearshift gear 26: fifth gearshift gear 27: sixth gearshift
gear 28: 5/6-th gearshift synchronizer
30: auxiliary input gear unit 31: auxiliary gear 32: clutch
40: output shaft 50: driving wheels 51: differential device.

### BEST MODES FOR CARRYING OUT THE INVENTION

The exemplary embodiments of the automated manual transmission of the present invention will be described with reference to the accompanying drawings.

During the above procedures, the thickness of the lines illustrated in the drawings and the dimensions of the components may be exaggerated for the sake of clarification and convenience of the descriptions.

In addition, the terms used below are defined in consideration of the functions in the present invention, and such terms may change based on the intention or custom of the user or the operator.

Therefore, the definitions of such terms should be interpreted based on the contents throughout the specification.

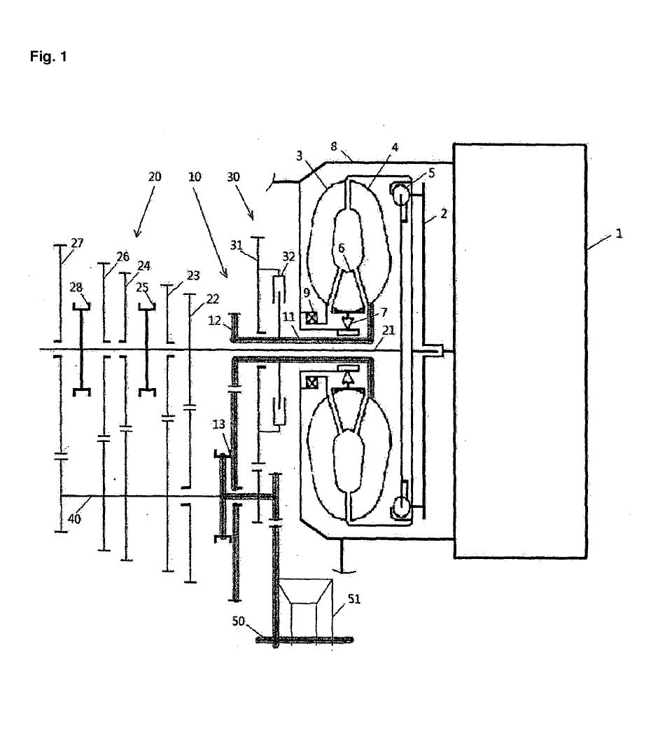

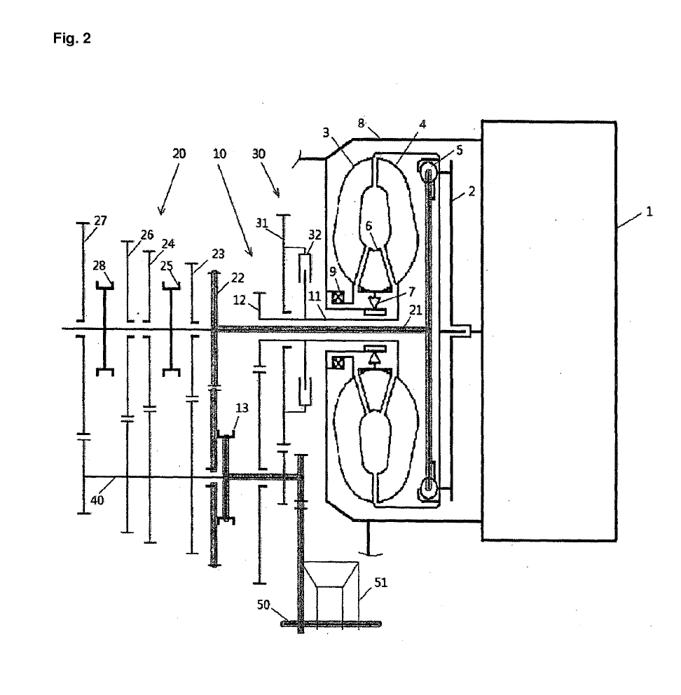

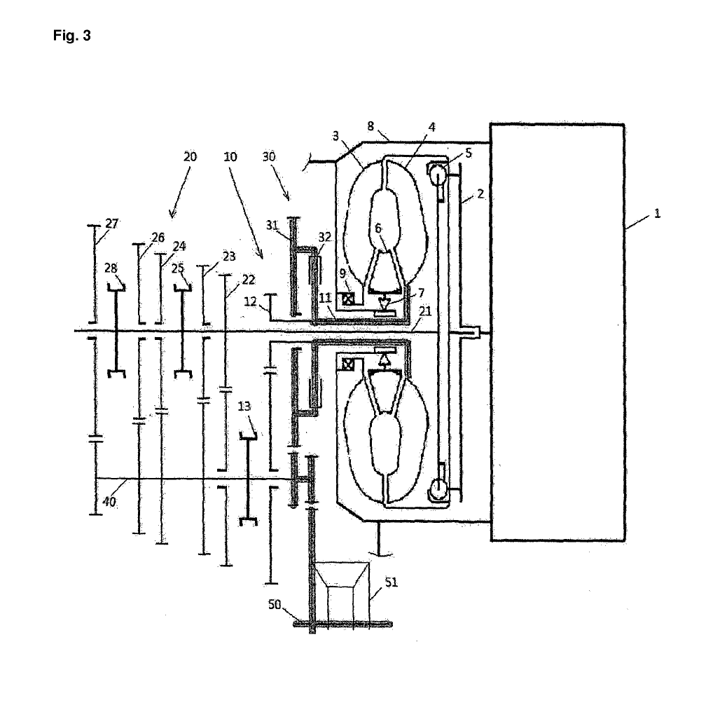

Referring to FIGS. 1, 2 and 3, the automated manual transmission according to an exemplary embodiment of the present invention comprises a first gearshift speed change gear unit 10, a second gearshift speed change gear unit 20 and an auxiliary input gear unit 30.

The first gearshift speed change gear unit 10 is configured to increase or decrease the rotational speed of the engine 1 based on a constant gear speed rate with respect to the driving force of the engine transferred through the torque converter and to transfer to driving wheels 50.

The second gearshift speed change gear unit 20 is directly connected to the engine 1 and increases or decreases the rotational speed of the engine 1 based on a constant gear speed rate with respect to the driving force of the engine through each of the speed change gears and transfers to the driving wheels 41.

The auxiliary input gear unit 30 intermits the auxiliary gear 31 connected to the output shaft 40 and the first input shaft 11 using the clutch 32 and transfers the rotational force of the engine 1 to the driving wheels 50 through the auxiliary gear 31 and the clutch 32 while the speed change operations are being performed by the first gearshift speed change gear unit 10 or the second gearshift speed change gear unit 20 at the time of the gear speed change.

The first gearshift speed change gear unit 10 includes a first input shaft 11, a first gearshift gear 12 and a synchronizer 13. The first input shaft 11 is connected to the turbine 4 of the torque converter, and the firs gearshift gear 11 is connected to the first input shaft 11. The ½-th gearshift synchronizer 13 connects the first gearshift gear 12 to the output shaft for thereby transferring a driving force.

Therefore, in case that the ½-th gearshift synchronizer 13 is connecting the first gearshift gear, the first gearshift gear is connected to the driving wheels 50, so the first gearshift gear rotates in proportion to the revolutions of the driving wheels 50. As the same state as the first gearshift speed change of the typical automated transmission, a creep driving or a stop state may be maintained when starting the engine.

The second gearshift speed change gear unit 20 includes a second input shaft 21 directly connected to the impeller 3 of the torque converter, speed change gears 22, 23, 24, 26 and 27 and synchronizers 13, 25 and 28.

Each of the speed change gears 22, 23, 24, 26 and 27 of the second gearshift gear to the sixth gearshift gear is installed at the second input shaft 21 and the output shaft 40, and each of the synchronizers 13, 25 and 28 are installed. Like the manual transmission, each of the speed change gears 22, 23, 24, 26 and 27 intermits the second input shaft 21 and the output shaft 40.

Meanwhile, each of the synchronizers 13, 25 and 28 may be substituted with a dog clutch.

The auxiliary input gear unit 30 includes an auxiliary gear 31, and a clutch 32.

The auxiliary gear 31 is set on the first input shaft 11 at a speed change rate smaller than the sixth gearshift gear, and the clutch 32 intermits the auxiliary gear 31 and the first input shaft 11.

The operations of the automated manual transmission according to an exemplary embodiment of the present invention having the above-described structure will be described as follows.

First, in a state wherein the engine is in operation, and the vehicle is stopped, in case that the gears are in the neutral position, the output shaft 40 is stopped along with the driving wheels 50, and the impeller 3, the second input shaft 21 connected to the impeller 3, the ¾-th gearshift synchronizer 25 and the ⅚-th synchronizer 28 rotate at the same revolutions as the engine 1. Meanwhile, the first input shaft 11 and the first gearshift gear 12 connected to the first input shaft 11 rotate at the same revolutions as the turbine 4. Since the auxiliary shaft 31 is connected to the output shaft 40, the auxiliary shaft 31 remains stopped.

At this time, at the neutral position, when the speed change lever is shifted to the forward diving shift “D”, the clutch 32 starts operating to connect the first input shaft 11 and the auxiliary gear 31, so the first input shaft 11 and the turbine 4 stop. When the ½-th gearshift synchronizer 13 connects the first gearshift gear, the speed change is completed.

After the speed change is completed, since the first gearshift gear 12 and the auxiliary gear 31 are simultaneously connected to the first input shaft 11, the output shaft 40 does not rotate. When the vehicle is supposed to start, and the clutch 32 is disconnected, only the first gearshift gear 12 is connected, so the driving becomes possible. When the vehicle is supposed to start at the uphill way based on the connection of the clutch 32, the vehicle can be prevented from moving backward using the above-described operation principle.

In case of the backward driving gear as not illustrated in FIG. 1, it is installed and connected to the first input shaft 11 like the first gearshift gear 12, and the speed change lever is handled from the neutral position to the rearward position “R”, the clutch 32 operates in the same way as the first gearshift speed change unit, and the first input shaft 11 is stopped, and then the backward driving gear is connected, so the speed change is completed.

In addition, when the vehicle starts on a downhill way with the backward driving gear, and the clutch 32 is connected, the auxiliary gear 31 and the backward driving gear are simultaneously connected, so the output shaft 40 does not rotate, so the vehicle may not move forward. When the clutch 32 is disconnected, the vehicle may move backward.

When the vehicle starts on the snowy way where the slipping of the driving wheels occurs on the road surface due to excessive torque, in a state wherein the first gearshift gear 12 or the backward driving gear is connected, the clutch 32 is operated, and part of the rotational torque is transferred through the auxiliary gear 31, so the function like the starting with the second gearshift gear in the typical automated transmission may be implemented.

When a speed change to the second gearshift gear is performed while the vehicle is driving on the first gearshift gear, the cutch 32 first operates, and the speed of the first input shaft 11 decreases. When the transfer torque increases in the clutch 32, the rotational speed of the engine 1 starts to decrease. At this time, the first gearshift gear 12 is disconnected by shifting the ½-th synchronizer 13 to the neutral position. When the first gearshift gear 12 is disconnected, it is controlled that the transfer torque of the clutch 32 can be maintained at a predetermined level.

When the rotational speed of the engine 1 decreases, and the rotational speed of the second gearshift gear 22 becomes same as the output shaft while the above-mentioned state is being held, the ½-th gearshift synchronizer is shifted to the side of the second gearshift gear to connect the second gearshift gear 22 and the output shaft 40.

The second gearshift gear 22 is connected to the output shaft 40, and at the same time the clutch 32 is disconnected. When only the second gearshift gear 22 becomes connected, the second gearshift speed change is completed.

When the speed change to the upper level gearshift such as a speed change from the second gearshift to the third gearshift, a speed change from the third gearshift to the fourth gearshift, etc. is necessary, the speed change may be performed in the same method as the above.

The rotational torque transferred through the auxiliary gear 31 during the gear speed change should be greater when the speed change is shifted to the second gearshift as compared with when the speed change is shifted to the sixth gearshift. In the present invention, the torque increased in proportion to the difference between the rotational speeds of the impeller 3 and the turbine 4 in the torque converter is transferred to the second input shaft 21. So, it is possible to obtain a rotational torque which is necessary during the speed change to each gearshift gear with only one set of the auxiliary gear 31.

The speed change may be performed by means of the engine control, etc. like the typical automated manual transmission when it needs to change the speed to the sixth gearshift gear by setting the gear ratio of the auxiliary gear 31 greater than the sixth gear ratio. Instead of the above, if necessary, when changing the speed to the second gearshift or the third gearshift, it may be possible to make enough large rotational torque be transferred through the auxiliary gear 31.

When the gear speed change is made to the lower level gearshift, for example, when the gear speed change is made from the sixth gearshift to the fifth gearshift, the clutch 32 first operates, and the driving force is transferred through the auxiliary gear 21, and when the transfer torque increases at the clutch 32, the rotational speed of the engine 1 starts to decrease. At this time, the sixth gearshift gear 27 is disconnected by shifting the ⅚-th synchronizer to the neutral position. When the sixth gearshift gear 27 is disconnected, the transfer torque at the clutch 32 is decreased in order for the clutch 32 to have the slipping, so the rotational speed of the engine 1 is controlled to increase.

In a state wherein the above-mentioned state is maintained, when the rotational speed of the engine 1 is increased, and the rotational speed of the fifth gearshift gear 26 becomes same as the output shaft 40, the ⅚-th synchronizer 28 is shifted to the side of the fifth gearshift, and the fifth gearshift gear 26 and the output shaft 40 are connected.

The fifth gearshift gear 26 is connected to the output shaft 40 and at the same time the clutch 32 is disconnected, so the fifth gearshift speed change is completed.

In case of the speed change to the lower level gearshift like a speed change from the fifth gearshift to the fourth gearshift, a speed change from the fourth gearshift to the third gearshift, etc., the speed change is performed in the same method as the above method.

### MODES FOR CARRYING OUT THE INVENTION

In case that the speed change ratio of the auxiliary gear 31 is set smaller than the sixth gearshift gear 28, another speed change gearshift, namely, the seventh gearshift gear may be made and operated by letting the driving force be transferred only through the auxiliary gear 31.

In addition, the auxiliary gear 31 may be directly connected to the first input shaft 11 and the differential device 50 through a belt so as to reduce the total length of the transmission. At this time, the auxiliary gear 31 may be operated in the same method even when intermitting, using the clutch, a portion between the output shat 40 or the differential device 51 in a state wherein the auxiliary gear 31 is always connected to the first input shaft 11.

### INDUSTRIAL APPLICABILITY

As described above, the present invention is characterized in that the driving force is transferred through each of the speed change gears when the speed change is not necessary, and while the gear speed change is under way, the driving force is transferred through the auxiliary gear 31, so the speed change is possible without any disconnection of the driving torque, whereby there will not be any run up in the engine in the course of the speed change, and any vibration and noise that the drive may feel is reduced.

The present invention has been described with reference to the exemplary embodiments in the drawings; however it is noted that the present invention is not limited to the exemplary embodiments illustrated in the drawing. The present invention may extend from the exemplary embodiments illustrated in the drawings to all the modified exemplary embodiments within a scope defined in the claims.

1. An automated manual transmission, comprising:
a torque converter connected to an engine and driven by the engine;
a first input shaft connected to a turbine of the torque converter and a first gearshift gear connected to the first input shaft;
a second input shaft connected to an impeller of the torque converter and one or a plurality of speed change gears connected to the second input shaft;
an auxiliary gear connected to the first input shaft;
a clutch configured to intermit the auxiliary gear and the first input shaft; and
an output shaft wherein the speed change gear is installed,
wherein while the gear speed change is under way, the rotational force of the engine is transferred to driving wheels through the auxiliary gear by the operation of the clutch.

2. The automated manual transmission of claim 1, wherein when the speed change is shifted from the neutral position to the first gearshift, the rotational speed of the first input shaft is decreased or stopped by operating the clutch, and the first gearshift gear and the output shaft are connected through a synchronizer or a dog clutch.

3. The automated manual transmission of claim 1, wherein part of the driving force of the engine is transferred through the auxiliary gear by operating the clutch in a state wherein the speed change is shifted to the first gearshift gear, so a small driving torque like when the vehicle starts with the second gearshift in the typical automated transmission is transferred.

4. The automated manual transmission of claim 1, wherein the vehicle does not move backward or forward on the uphill way or the downhill way in such a way that the driving force is transferred through the auxiliary gear by operating the clutch in a state wherein the speed change is shifted to the first gearshift gear.

5. The automated manual transmission of claim 1, wherein the auxiliary gear is connected to the first input shaft, and the clutch is configured to intermit the output shaft and the auxiliary gear.

6. The automated manual transmission of claim 1, wherein a second auxiliary gear is installed at the differential device and is engaged to the auxiliary gear and rotates.

7. The automated manual transmission of claim 1, wherein the auxiliary gear is installed at the first input shaft and the differential device, respectively, and the auxiliary gears at both sides are connected through a chain.

8. The automated manual transmission of claim 6, wherein the clutch does not intermit the auxiliary gear and the first input shaft or the output shaft, but intermits the auxiliary gear installed at the differential device and the differential device.

9. The automated manual transmission of claim 1, wherein the speed change ratio transferred through the auxiliary gear or the second auxiliary gear is set smaller than the speed change ratio of the highest level gearshift of the speed change gear installed at the second input shaft.

10. The automated manual transmission of claim 1, wherein the driving force from the engine is transferred only through the auxiliary gear or the second auxiliary gear during the driving after the speed change is completed.

11. The automated manual transmission of claim 10, wherein the auxiliary gear is installed at the second output shaft separately installed between the first input shaft and the differential device, and the driving force of the engine is transferred to the driving wheels through the first input shaft, the second output shaft and the differential device while the gear speed change is under way.
